(19) United States
(12) Patent Application Publication
(10) Pub. No.: US 2025/0347980 A1
(43) Pub. Date: Nov. 13, 2025

(54) CAMERA MODULE, ELECTRONIC DEVICE AND POSITION DETECTION METHOD FOR CAMERA MODULE

(71) Applicant: AAC Optics Solutions Pte. Ltd., Singapore (SG)

(72) Inventors: Kazuo Shikama, Osaka (JP); Takashi Iwasaki, Osaka (JP)

(21) Appl. No.: 18/986,559

(22) Filed: Dec. 18, 2024

(30) Foreign Application Priority Data
May 8, 2024 (JP) 2024-075721

(51) Int. Cl. G03B 9/06; G03B 13/36; G03B 17/17

(52) U.S. Cl. CPC G03B 9/06; G03B 13/36; G03B 17/17

(57) ABSTRACT

A camera module, an electronic device and a position detection method for the camera module are provided according to the present disclosure. The camera module includes an autofocus mechanism, an adjustable diaphragm mechanism and a linkage mechanism. A focus driving assembly drives a supporting frame to drive a lens to move, so that the autofocus mechanism realizes focusing movement. When the lens moves, the linkage mechanism drives a blade driving assembly to drive a shading blade to move according to a current position of the lens in an optical axis, so as to adaptively change a shading area of the shading blade on the lens. In this way, the focusing movement of the lens can be linked with the aperture adjustment movement of the adjustable diaphragm, thereby realizing the consistent adjustment of the lens focus and the aperture of the diaphragm.

### TECHNICAL FIELD

The embodiments of the present disclosure relate to the technical field of camera devices, and in particular to a camera module, an electronic device, and a position detection method for the camera module.

### BACKGROUND

An aperture (adjustable diaphragm) is used to change the amount of light entering an optical system to participate in imaging. Setting the diaphragm in the camera module allows the camera module to adapt to the shooting requirements of different light and dark scenes by adjusting the diaphragm. A focusing mechanism can achieve the focusing of the camera module by changing the position of the lens, so that the camera module can shoot a target object more clearly. The combination of the diaphragm and the focusing mechanism can improve the shooting performance of the camera module. Therefore, the application of the camera modules with the diaphragm and the focusing mechanism in electronic devices such as smartphones, tablets, etc. is favored by a large number of consumers.

### TECHNICAL PROBLEMS

The blade driving mechanism drives multiple blades to move, resulting in changes in the size of the openings surrounded by these blades, which can be applied to different optical units in cameras such as shutters, diaphragms, or filters. The existing adjustable diaphragm, corresponding to the driving mechanism, is arranged on the lens and located on an object side of the lens, which increases the weight of the object side of the lens, easily causes the lens to tilt and affects the focus driving of the lens. If a leaf spring is used, it is necessary to increase the hardness of the leaf spring to support the lens with an adjustable diaphragm. Even without using a leaf spring, the focusing mechanism still needs to provide the same amount of holding force. In addition, it is necessary to set internal electrical wiring to drive the adjustable diaphragm, ensuring that the electrical wiring does not affect focusing, so that the design of the overall solution is more difficult. In addition, when the lens is driven by the focusing mechanism to move, the distance between the lens and the adjustable diaphragm is changed, resulting in a change in the field of view that the lens can capture relative to the aperture of the diaphragm, requiring the user to adjust the adjustable diaphragm separately.

Therefore, a new camera module is urgently needed in the art to solve one or more of the above technical problems.

### SUMMARY

An object according to the embodiments of the present disclosure is to provide a camera module and an electronic device, so that the focusing movement of the lens can be linked with the aperture adjustment movement of the adjustable diaphragm, thereby realizing consistent adjustment of the lens focus and the aperture of the diaphragm.

In order to solve the above technical problems, a camera module is provided according to an embodiment of the present disclosure, which includes: a lens, an autofocus mechanism, including a supporting frame and a focus driving assembly, where the supporting frame is sleeved on and fixed to an outer circumference of the lens to support the lens, and the focus driving assembly is configured to drive the supporting frame to move the lens along an optical axis of the lens, an adjustable diaphragm mechanism, including a blade support, a shading blade and a blade driving assembly, where the blade support, the shading blade and the blade driving assembly are located on an object side of the lens, the blade support and the lens are coaxially arranged, and the shading blade is located between the blade support and the blade driving assembly, where the blade support has a positioning hole, the shading blade has a positioning portion, the positioning portion rotatably extends into the positioning hole, and the shading blade is rotatable around the positioning portion, and a linkage mechanism, where in response to the focus driving assembly driving the supporting frame to drive the lens to move, the linkage mechanism drives the blade driving assembly to drive the shading blade to move, to adaptively change a shading area of the shading blade on the lens.

An electronic device is provided according to an embodiment of the present disclosure, which includes a device body and the camera module according to any one of of the above, where the camera module is arranged on the device body.

A position detection method for the camera module, is provided according to an embodiment of the present disclosure, which includes: detecting, by the first position detection element, a position of the supporting frame in the optical axis, and sending, by the first position element, a first electrical signal carrying position information of the supporting frame to the driver, detecting, by the second position detection element, a position of the blade driven ring in a direction perpendicular to the optical axis and sending, by the second position detection element, a second electrical signal carrying position information of the blade driven ring to the driver, receiving, by the driver, the first electrical signal and the second electrical signal, and determining, by the driver, whether the position information of the supporting frame corresponds to the position information of the blade driven ring according to a preset corresponding relationship, if the position information of the supporting frame corresponds to the position information of the blade driven ring according to the preset corresponding relationship, sending, by the driver, a first control signal to the blade driving assembly, and receiving, by the blade driving assembly, the first control signal to drive the blade driven ring to keep a current position, and if the position information of the supporting frame does not correspond to the position information of the blade driven ring according to the preset corresponding relationship, sending, by the driver, a second control signal to the blade driving assembly, and receiving, by the blade driving assembly, the second control signal to drive the blade driven ring to drive the shading blade to move.

Another position detection method for the camera module, is provided according to an embodiment of the present disclosure, which includes: detecting, by the first position controller, a position of the second position controller, detecting, by the second position controller, a position of the first position controller, and determining, by the first position controller and the second position controller, whether the relative position between the first position controller and the second position controller is changed, if the relative position between the first position controller and the second position controller is changed, sending, by the first position controller and/or the second position controller, a first control signal to the blade driving assembly, and receiving, by the blade driving assembly, the first control signal to drive the blade driven ring to drive the shading blade to move, if the relative position between the first position controller and the second position controller is not changed, sending, by the first position controller and/or the second position controller, a second control signal to the blade driving assembly, and receiving, by the blade driving assembly, the second control signal to drive the blade driven ring to keep a current position.

### BENEFICIAL EFFECTS

Compared with the related art, the camera module of the embodiments of the present disclosure includes the autofocus mechanism, the adjustable diaphragm mechanism and the linkage mechanism. The focus driving assembly drives the supporting frame to drive the lens to move, so that the autofocus mechanism realizes focusing movement. When the lens moves, the linkage mechanism drives the blade driving assembly to drive the shading blade to move according to the current position of the lens in the optical axis, so as to adaptively change the shading area of the shading blade on the lens. In this way, the focusing movement of the lens can be linked with the aperture adjustment movement of the adjustable diaphragm, thereby realizing the consistent adjustment of the lens focus and the aperture of the diaphragm.

### BRIEF DESCRIPTION OF THE DRAWINGS

One or more embodiments are illustrated by corresponding figures in the accompanying drawings, which do not constitute limitations on the embodiments. Elements with the same reference numerals in the accompanying drawings represent similar elements, and unless otherwise specified, the figures in the accompanying drawings do not constitute scale limitations.

FIG. 1 is a schematic perspective view of a camera module according to an embodiment of the present disclosure.

FIG. 2 is schematic diagram showing an assembly of an adjustable diaphragm mechanism of a camera module according to an embodiment of the present disclosure.

FIG. 3 is a schematic exploded view of the camera module according to the embodiment of the present disclosure.

FIG. 4 is a schematic front view of the camera module according to the embodiment of the present disclosure.

FIG. 5 is a schematic diagram showing cooperation between a second driving member and a second driven member of the camera module according to an embodiment of the present disclosure.

FIG. 6 is a schematic perspective diagram showing an object side of a shading blade of the camera module according to an embodiment of the present disclosure.

FIG. 7 is a schematic perspective diagram showing an image side of the shading blade of the camera module according to an embodiment of the present disclosure.

FIG. 8 is a schematic side view of the shading blade of the camera module according to an embodiment of the present disclosure.

FIG. 9 is a schematic perspective view of a blade support of the camera module according to an embodiment of the present disclosure.

FIG. 10 is a schematic perspective view of a blade driven ring of the camera module according to an embodiment of the present disclosure.

FIG. 11 is a schematic diagram showing a state that the adjustable diaphragm mechanism of the camera module has a maximum aperture according to an embodiment of the present disclosure.

FIG. 12 is a schematic diagram showing a state that the adjustable diaphragm mechanism of the camera module has a minimum aperture according to an embodiment of the present disclosure.

FIG. 13 is a schematic diagram of a linkage mechanism of the camera module according to an embodiment of the present disclosure.

FIG. 14 is a schematic diagram of another linkage mechanism of the camera module according to an embodiment of the present disclosure.

FIG. 15 is a schematic diagram of another linkage mechanism of the camera module according to an embodiment of the present disclosure.

FIG. 16 is a schematic diagram of a telescopic zoom mechanism of the camera module according to an embodiment of the present disclosure.

FIG. 17 is a schematic diagram of an optical path folding mechanism of the camera module according to an embodiment of the present disclosure.

FIG. 18 is a schematic diagram of a linkage mechanism of a camera module according to another embodiment of the present disclosure.

FIG. 19 is a cross-sectional view of the camera module taken along line AA′ in FIG. 4.

FIG. 20 is a schematic perspective view of a blade driven ring of the camera module according to an embodiment of the present disclosure.

FIG. 21 is a schematic diagram of a blade angle holder of the camera module according to an embodiment of the present disclosure.

FIG. 22 is a schematic diagram of another blade angle holder of the camera module according to an embodiment of the present disclosure.

FIG. 23 is a schematic perspective view of an electronic device according to an embodiment of the present disclosure.

FIG. 24 is a schematic view of a position detection method for a camera module according to an embodiment of the present disclosure.

FIG. 25 is a schematic view of a position detection method for a camera module according to another embodiment of the present disclosure.

### DETAILED DESCRIPTION OF THE EMBODIMENTS

In order to make the purpose, technical solutions and advantages of the embodiments of the present disclosure more clear, the embodiments of the present invention will be described in detail with the attached drawings. However, it can be understood by those skilled in the art that in various embodiments of the present disclosure, many technical details are set forth for readers to better understand the present disclosure. However, even without these technical details and various changes and modifications based on the following embodiments, the technical solutions claimed by the present disclosure can be realized.

The purpose of embodiments of the present disclosure is to provide a camera module, so that the focusing movement of a lens can be linked with the aperture adjustment movement of an adjustable diaphragm, thereby realizing consistent adjustment of the lens focus and the aperture of the diaphragm.

The camera module is provided according to the embodiments of the present disclosure, which includes an autofocus mechanism, an adjustable diaphragm mechanism and a linkage mechanism. The focus driving assembly drives the supporting frame to drive the lens to move, so that the autofocus mechanism realizes focusing movement. When the lens moves, the linkage mechanism drives the blade driving assembly to drive the shading blade to move according to the current position of the lens in the optical axis, so as to adaptively change the shading area of the shading blade on the lens. In this way, the focusing movement of the lens can be linked with the aperture adjustment movement of the adjustable diaphragm, thereby realizing the consistent adjustment of the lens focus and the aperture of the diaphragm.

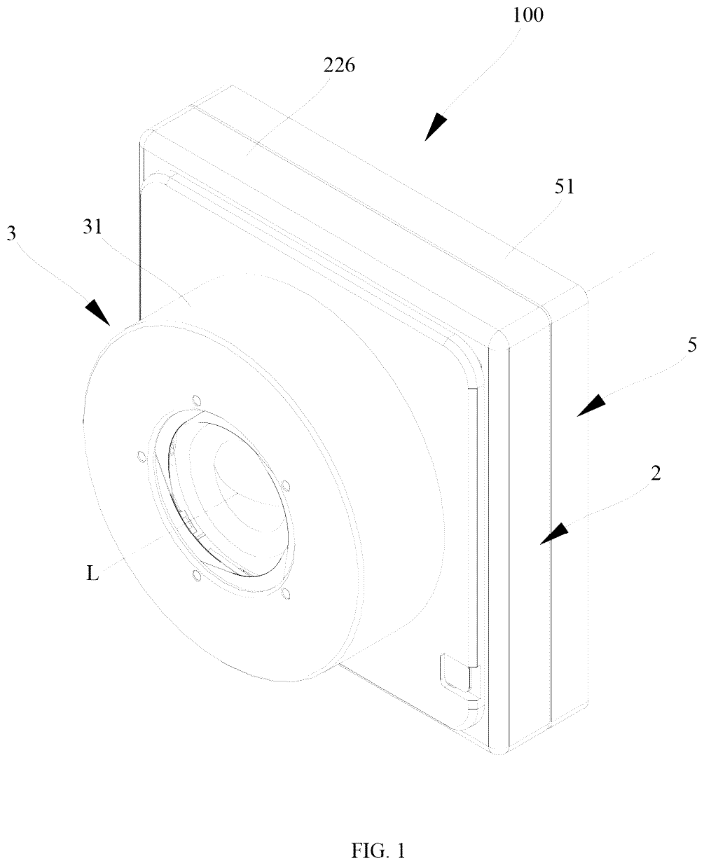

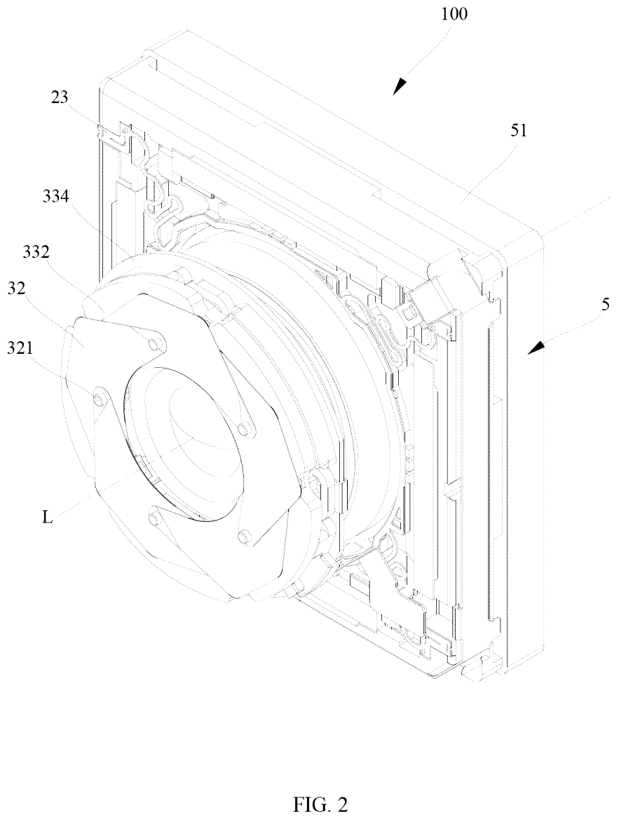

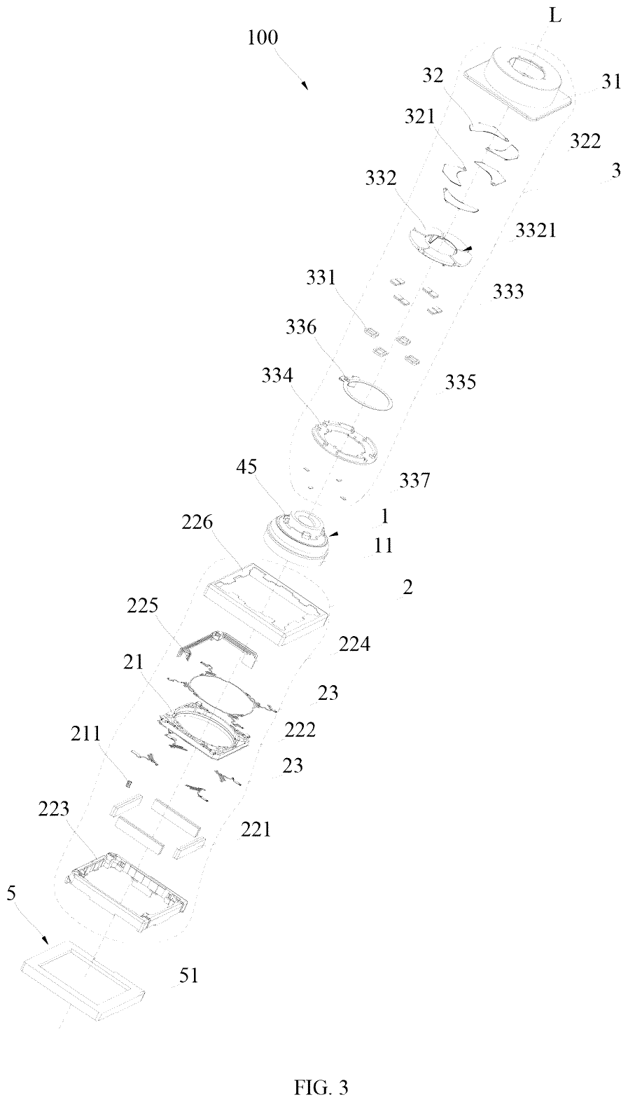

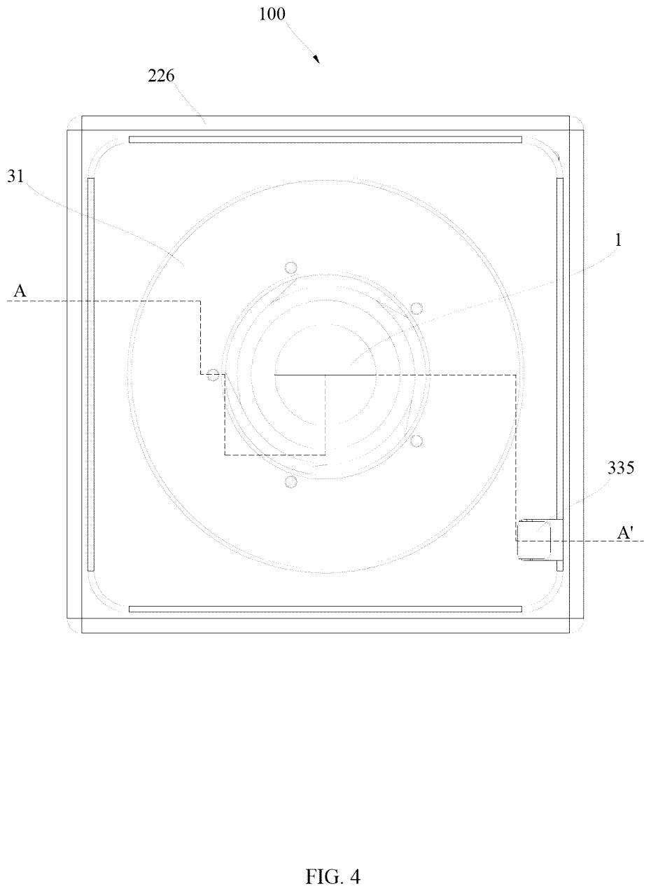

Referring to FIG. 1 to FIG. 4, a camera module 100 according to a first embodiment of the present disclosure includes a lens 1, an autofocus mechanism 2, an adjustable diaphragm mechanism 3, and a linkage mechanism 4. The autofocus mechanism 2 includes a supporting frame 21 and a focus driving assembly 22. The supporting frame 21 is sleeved on and fixed to a periphery of the lens 1 to support the lens 1, and the focus driving assembly 22 drives the lens 1 to move along an optical axis L by driving the supporting frame 21. The adjustable diaphragm mechanism 3 includes a blade support 31, a shading blade 32, and a blade driving assembly 33. The blade support 31, the shading blade 32, and the blade driving assembly 33 are all located on an object side of the lens. The blade support 31 and the lens 1 are coaxially arranged, and the shading blade 32 is located between the blade support 31 and the blade driving assembly 33. The blade support 31 has a positioning hole 311, the shading blade 32 has a positioning portion 321, and the positioning portion 321 rotatably extends into the positioning hole 311. The shading blade 32 is rotatable around the positioning portion 321. When the focus driving assembly 22 drives the supporting frame 21 to drive the lens 1 to move, the linkage mechanism 4 drives the blade driving assembly 33 to drive the shading blade 32 to move, thereby adaptively changing a shading area of the shading blade 32 on the lens 1.

In this way, the focusing movement of the autofocus mechanism 2 on the lens 1 can be linked with the aperture adjustment movement of the adjustable diaphragm mechanism 3, thereby realizing the consistent adjustment of the lens focus and the aperture of the diaphragm.

In this embodiment, the lens 1 is supported on the supporting frame 21 by a leaf spring 23.

In this embodiment, the focus driving assembly 22 includes a first driving member and a first driven member. The first driven member is arranged on the supporting frame 21, and the first driving member is arranged opposite to the first driven member. The first driving member is fixed and configured to drive the first driven member to move along the optical axis L to drive the lens 1 to move.

Further, the focus driving assembly 22 includes a mounting seat 223, which surrounds the supporting frame 21 and is arranged on an outer side of the supporting frame 21. The supporting frame 21 is movable along the optical axis L relative to the mounting seat 223, and the first driving member is fixed to the mounting seat 223.

In some embodiments, the first driven member is a plurality of first magnetic steels 221, the first driven member is a first coil 222 wound around a periphery of the supporting frame 21, and the plurality of first magnetic steels 221 surround the first coil 222 and arranged at intervals on an outer side of the first coil 22. When the first coil 222 is energized, the magnetic field generated by the first coil 222 interacts with the magnetic field of the first magnetic steels 221 itself. Since the first magnetic steels 221 are fixed to the mounting seat 223, the first coil 222 is affected by the interaction of the magnetic fields and moves along the optical axis L, thereby driving the supporting frame 21 and the lens 1 to move along the optical axis L. By changing the direction of the current passing through the first coil 222, the moving direction of the lens 1 can be changed. By changing the magnitude of the current passing through the first coil 222, the moving distance of the lens 1 in the optical axis can be changed.

It can be understood that the plurality of first magnetic steels 221 can surround the supporting frame 21 and be fixed at intervals on the periphery of the supporting frame 21, and the first coil 222 is wound around an inner side or the periphery of the mounting seat 223. The first magnetic steels 221 and the first coil 222 need to keep a certain interval, that is, the positions of the first magnetic steels 221 and the first coil 222 need to be exchanged. In this case, the first driving member is the first coil 222 and the first driven member is the first magnetic steels 221.

In this embodiment, the focus driving assembly 22 further includes a first energized substrate 224, and the first coil 222 is electrically connected with the first energized substrate 224, and the first energized substrate 224 is configured to supply power to the first coil 222.

Further, the focus driving assembly 22 further includes a first position detection element 225 arranged on the mounting seat 223, the first energized substrate 224 is electrically connected with the first position detection element 225, and the first position detection element 225 is configured to detect a position of the supporting frame 21 to determine a current position of the lens 1 in the focusing movement.

In some embodiments, the first position detection element 225 is a Hall element, and a magnetic member 211 is arranged on the supporting frame 21. When the supporting frame 21 moves along the optical axis L, the magnetic member 211 moves relative to the mounting seat 223, and a magnetic field of the magnetic member 211 is changed at the position of the Hall element. The Hall element detects a position of the magnetic member 211 by detecting the change of the magnetic field, so as to determine the position of the lens 1.

In this embodiment, the focus driving assembly 22 further includes a front housing 226, and the camera module 100 includes a rear housing 51. The remaining components of the focus driving assembly 22 are accommodated in a space surrounded by the front housing 226 and the rear housing 51, and the mounting base 223 is fixed.

In this embodiment, the blade driving assembly 33 includes a second driving member and a blade driven ring 332. The second driving member is arranged between the shading blade 32 and the lens 1, and the blade driven ring 332 is arranged between the shading blade 32 and the second driving member. The second driving member drives the blade driven ring 332 to drive the shading blade 32 to move, so as to change a shading area of the shading blade 32 on the lens 1. Specifically, the blade driving assembly 33 further includes a second driven member fixed to the blade driven ring 332, and the second driving member drives the blade driven ring 332 and the shading blade 32 to move by driving the second driven member.

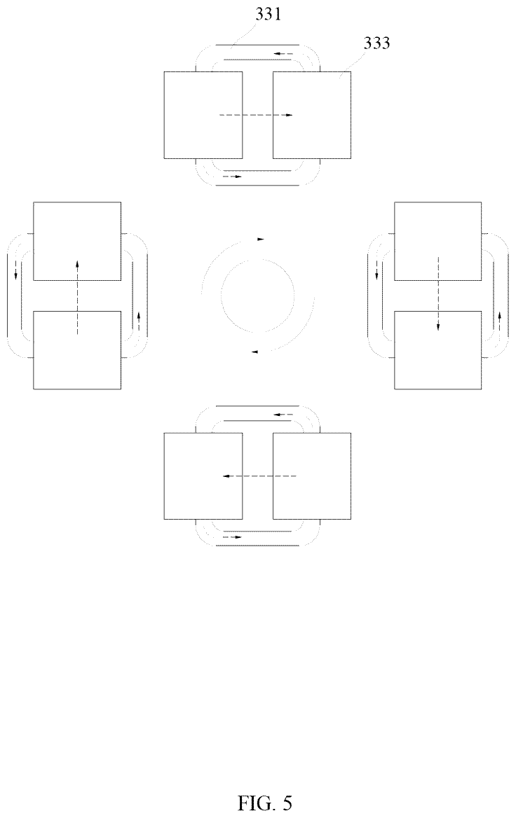

In some embodiments, the blade driving assembly 33 further includes a mounting ring 334 arranged between the blade driven ring 332 and the lens 1, and the blade driven ring 332 is rotatable relative to the mounting ring 334. The second driving member is a plurality of second coils 331 and the second driven member is a plurality of second magnetic steels 333. The plurality of second coils 331 are distributed around the optical axis L and fixed to the mounting ring 334 at intervals, the plurality of second magnetic steels 333 are distributed around the optical axis and fixed to the blade driven ring 332 at intervals, and the second magnetic steels 333 and the second coils 331 are oppositely arranged in one-to-one correspondence. Referring to FIG. 5, the dashed curved arrow is the direction of the current, the dashed straight arrow is the stress direction of the second magnetic steels 333, and the solid curved arrow is the rotation direction of the blade driven ring 332. Take the second coil 331 located above as an example, when the counterclockwise current passes through the second coil 331, the magnetic field generated by the second coil 331 interacts with the magnetic field of the second magnetic steel 333, so that the second magnetic steel 333 moves along its stress direction. Different second magnetic steels 333 are influenced by the second coils 331 corresponding to positions of the second magnetic steels. When these forces act together, the second magnetic steels 333 drive the blade driven ring 332 to rotate clockwise around the optical axis L, and then the blade driven ring 332 drives the shading blade 32 to move. In this way, by changing the direction of the current passing through the second coil 331, the stress direction of the second magnetic steels 333 can be changed, thereby changing the rotation direction of the blade driven ring 332. When the blade driven ring 332 moves in a specific direction, the shielding area of the shading blade 32 on the lens 1 can be increased. When the blade driven ring 332 rotates in another direction, the shielding area of the shading blade 32 on the lens 1 can be reduced. When one second coil 331 is provided, it is arranged offset from the optical axis and fixed to the mounting ring 334. When one second magnetic steel 333 is provided, it is arrange offset from the optical axis and fixed to the blade driven ring 332.

It can be understood that changing the current passing through the second coil 331 can change the force on the second magnetic steels 333, thus changing the rotation angle of the blade driven ring 332.

In other embodiments, the second driving member may be the second magnetic steels 333, and the second driven member may be the second coils 331, that is, the positions of the second coils 331 and the second magnetic steels 333 are exchanged.

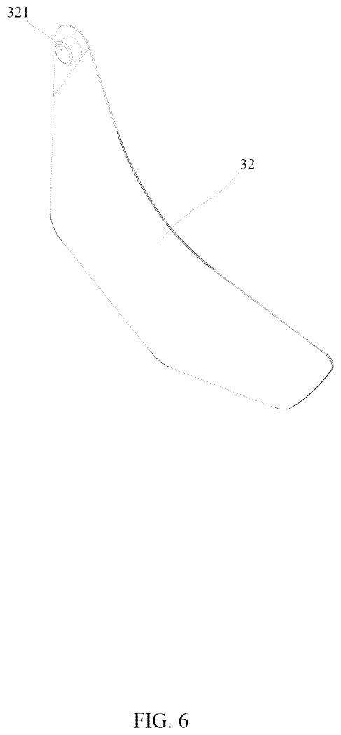

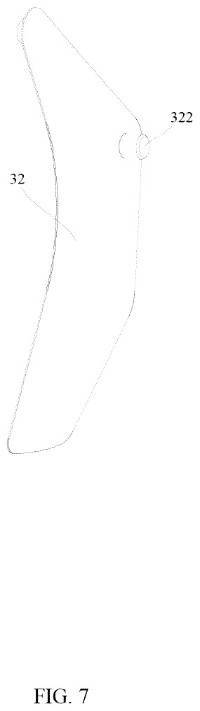

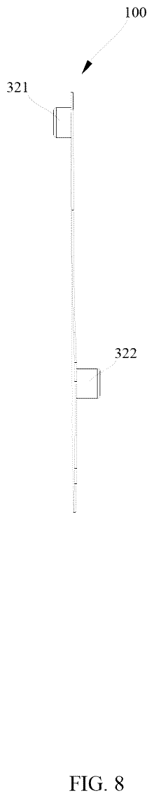

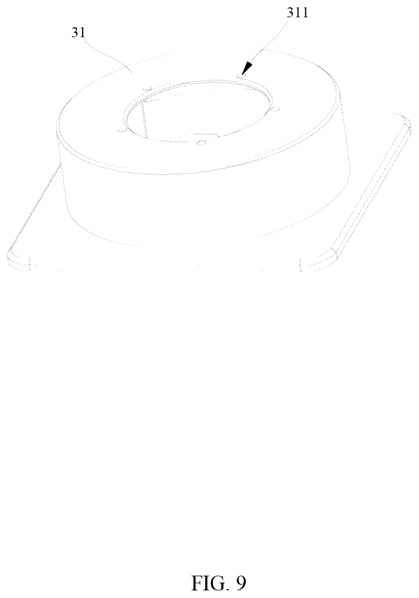

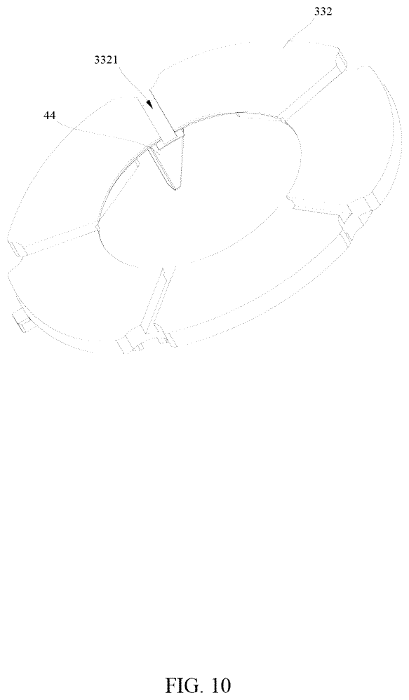

Referring to FIG. 6 to FIG. 10, in this embodiment, a surface of the shading blade 32 facing the blade support 31 is provided with a positioning portion 321, and a surface facing the blade driven ring 332 is provided with a sliding portion 322. The blade support 31 has a positioning hole 311, and the blade driven ring 332 has a sliding groove 3321. The positioning portion 321 extends into the positioning hole 311, and the sliding portion 322 extends into the sliding groove 3321 and slides in the sliding groove 3321. When the blade driven ring 332 rotates, the sliding portion 322 is constrained by an inner wall of the sliding groove 3321, and slides in the sliding groove 3321 while following the rotation of the blade driven ring 332. Since the positioning portion 321 extends into and is constrained by the positioning hole 311, the positioning portion 321 rotates relative to the blade support 31 but remains unchanged in position, so that the whole shading blade 32 moves in a plane perpendicular to the optical axis L. Further, the sliding groove 3321 extends in a radial direction of the blade driven ring 332. In the present disclosure, the “sliding connection” between the sliding portion 322 and the blade driven ring 332 means that the sliding portion 322 rotates with the positioning portion 321 as a pivot axis under the action of the sliding groove 3321 of the blade driven ring 332, and the sliding portion 322 slides in the sliding groove 3321 relative to the blade driven ring 332 during rotation.

It should be noted that projections of the positioning portion 321 and the sliding portion 322 on an extension plane of the shading blade 32 do not overlap, that is, the projections are staggered. Moreover, the positioning portion 321 is generally arranged at one end of the shading blade 32, and the sliding portion 322 can be arranged at the other end or the middle portion of the shading blade 32.

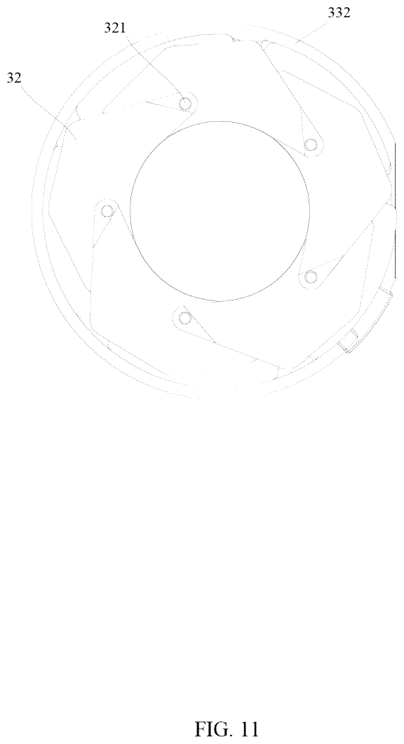

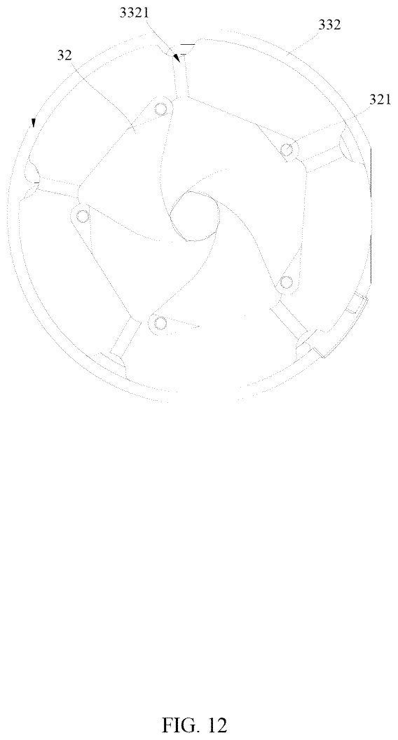

Referring to FIG. 11 and FIG. 12, more specifically, a plurality of shading blades 32 are provided, which are arranged at intervals around the optical axis L. The plurality of shading blades 32 are arranged at intervals in a circumferential direction of the blade driven ring 332, and any two adjacent shading blades 32 are overlapped. For example, an end of one shading blade 32 provided with the positioning portion 321 is placed on an image side of a shading blade 32 adjacent to the end, and another end of the one shading blade 32 provided with the sliding portion 322 is placed on an object side of a shading blade 32 adjacent to the another end. The same applies to other shading blades. Correspondingly, the blade support 31 has a plurality of positioning holes 311 at intervals in the circumferential direction, and the blade driven ring 332 has a plurality of sliding grooves 3321 at intervals in the circumferential direction.

It can be understood that a plurality of shading blades 32 form a through hole around the optical axis L. When the shading blades 32 move, a size of the through hole can be changed accordingly, thus changing an exposed area of the lens 1 and the luminous flux of the adjustable diaphragm mechanism 3.

Alternatively, the shading blade 32 may be in the shape of an arc, or an inner edge of the shading blade 32 surrounding the through hole is an arc edge, and an outer edge is an edge with other shapes.

In this embodiment, the blade support 31 has a cylindrical groove, the bottom of the cylindrical groove has a circular through hole coaxial with the lens 1, and the blade driven ring 332 and the cylindrical groove together form a blade chamber for accommodating the above shading blade 32. More specifically, the blade support 31 is a blade cover fixed to the front housing 226, and the blade driving assembly 33 is accommodated in the space formed by the blade cover and the front housing 226.

In this embodiment, the mounting ring 334 is provided with a second energized substrate 335, and the second energized substrate 335 is electrically connected with all the second coils 331 arranged on the mounting ring 334 for supplying power to the second coils 331. Further, a second position detection element 336 electrically connected with the second electrified substrate 335 is arranged on the mounting ring 334. The second position detection element 336 is a Hall element, which detects a position of a magnetic steel on the blade driven ring 332 to determine the position of the blade driven ring 332 after rotation, so as to obtain the rotation angle of the blade driven ring 332. Therefore, the change of the aperture of the adjustable diaphragm can be obtained by calculation.

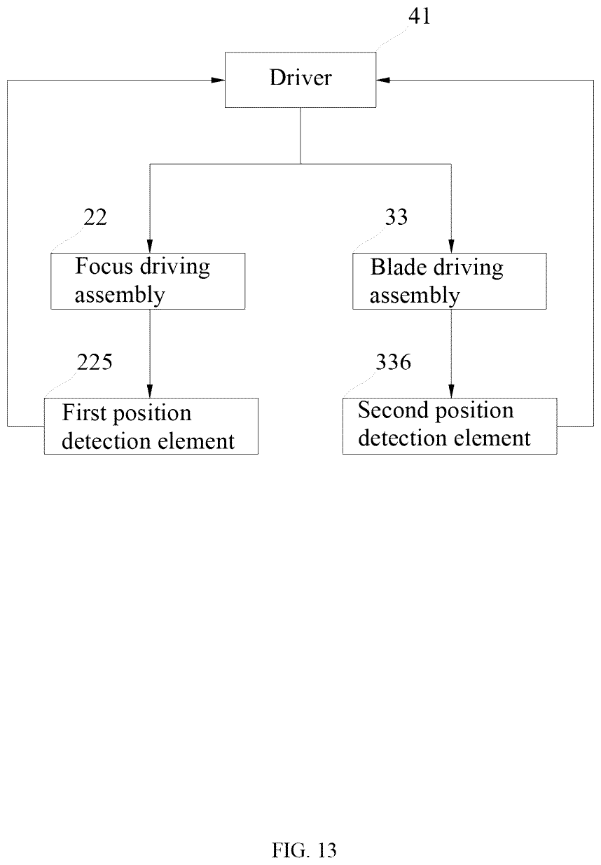

Referring to FIG. 13, in this embodiment, the linkage mechanism 4 includes a driver 41, and the driver 41 is electrically connected with the focus driving assembly 22 and the blade driving assembly 33. The focus driving assembly 22 can detect the position of the supporting frame 21. When the focus driving assembly 22 drives the supporting frame 21 to drive the lens 1 to move, the focus driving assembly 22 detects the position of the supporting frame 21 to determine the current position of the lens 1, and sends the current position of the lens 1 to the driver 41. The driver 41 controls the blade driving assembly 33 according to the current position of the lens 1, so that the blade driving assembly 33 drives the blade driven ring 332 to drive the shading blade 32 to move.

Specifically, the driver 41 is electrically connected with the first coil 222 and the first position detection element 225 of the focus driving assembly 22, and the position of the supporting frame 21 is detected by the first position detection element 225 to determine the current position of the lens 1.

More specifically, the driver 41 is further electrically connected with the second coil 331 and the second position detection element 336 of the blade driving assembly 33. When the focus driving assembly 22 drives the lens 1 to move, the first position detection element 225 sends the detected position information of the lens 1 (that is, the current position after the movement) to the driver 41, and the second position detection element 336 detects and sends the position information of the blade driven ring 332 before rotation to the driver 41. After receiving the position information of the lens 1, the driver 41 combines the position of the blade driven ring 332 before rotation and calculates, to obtain a change of the rotation angle of the blade driven ring 332 corresponding to the change of the position of the lens 1. A current signal including the position control information is sent to the second coil 331 of the blade driving assembly 33, so that the blade driven ring 332 is driven to rotate by the second coil 331, and the field of view of the lens 1 formed by the aperture of the diaphragm before and after focusing is unchanged. Moreover, the second position detection element 336 can detect the position of the rotated blade driven ring 332 and feed it back to the driver 41, and the driver 41 can further determine whether the position of the rotated blade driven ring 332 meets the requirements, so as to timely correct the position of the blade driven ring 332.

It can be understood that the corresponding relationship between the distance that the lens 1 moves along the optical axis L and the change of the rotation angle of the blade driven ring 332, and the corresponding relationship between the change of the rotation angle of the blade driven ring 332 and the aperture of the diaphragm are all related to the shapes and sizes of the above components, so the specific corresponding relationship can be configured by setting the shapes and sizes of these components as required, which is not described in detail herein.

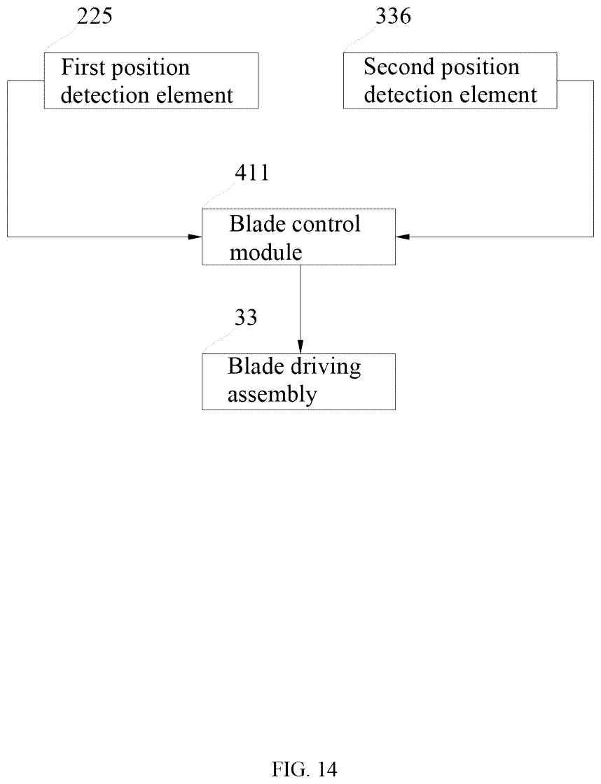

Referring to FIG. 14, in other embodiments, the driver 41 may further include a blade control module 411, the first position detection element 225 is electrically connected with the blade control module 411, and the second coil 331 and the second position detection element 336 of the blade driving assembly 33 are electrically connected with the blade control module 411. The blade control module 411 detects the change of the position of the lens 1 before and after focusing by the first position detection element 225, detects the position of the blade driven ring 332 by the second position detection element 336, and sends a control signal to the blade driving assembly 33 according to the change of the position and the position of the blade driven ring 332, so as to drive the blade driven ring 332 to rotate. Similarly, the blade control module 411 can also correct the position of the blade driven ring 332 according to the position of the rotated blade driven ring 332 detected by the second position detection element 336.

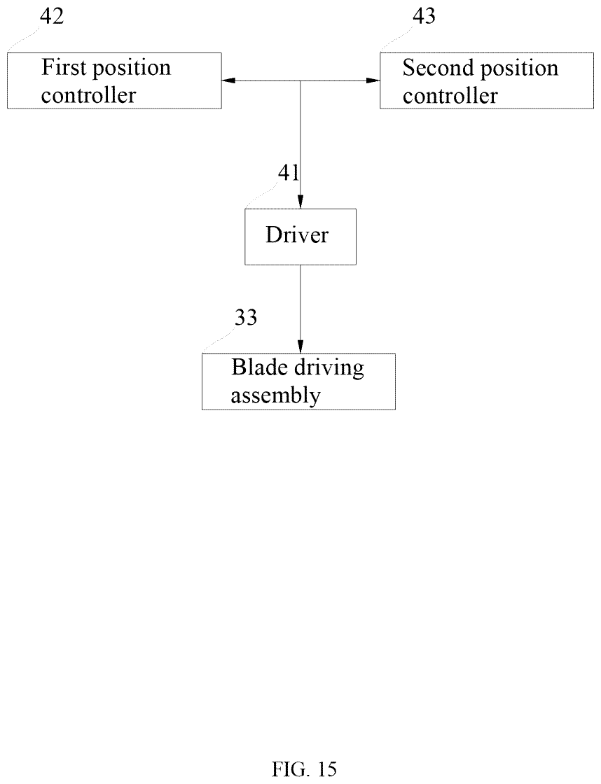

Referring to FIG. 15, in other embodiments, the linkage mechanism 4 further includes a first position controller 42 and a second position controller 43, and the first position controller 42 and the second position controller 43 are electrically connected with the driver 41. The first position controller 42 is arranged on the supporting frame 21, the second position controller 43 is arranged on the mounting ring 334, and the first position controller 42 and the second position controller 43 are configured to detect a relative position change of each other. After receiving the monitoring information from the first position controller 42 and the second position controller 43, the driver 41 determines the current position of the lens 1 according to the information, and sends a control signal to the blade driving assembly 33, so that the blade driving assembly 33 drives the blade driven ring 332 to rotate. Alternatively, the second position controller 43 may be arranged on the blade driven ring 332.

In some embodiments, the autofocus mechanism 2 further includes a zoom assembly 24, and the zoom assembly 24 is configured to drive the focus driving assembly 22 and the supporting frame 21 to move along the optical axis to realize zooming. Optionally, the zoom assembly 24 includes a telescopic zoom structure 241, and the focus driving assembly 22 is mounted on the telescopic zoom structure 241, so that a focal length of the camera module 100 can be changed by the expansion and retraction of the telescopic zoom structure 241. Alternatively, the zoom assembly 24 has a fixed-position zoom mode, for example, a zoom lens can be used. There are various options for the zoom lens, such as a force-deformable liquid lens, a mechanical-force-driven flexible zoom lens (thin film lens), an electromagnetic-driven zoom lens, an electro-deformable flexible zoom lens, and a flexible zoom lens based on electroactive polymers.

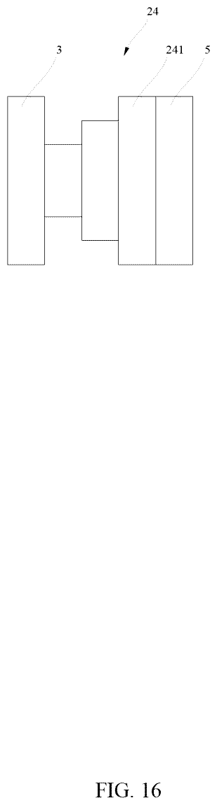

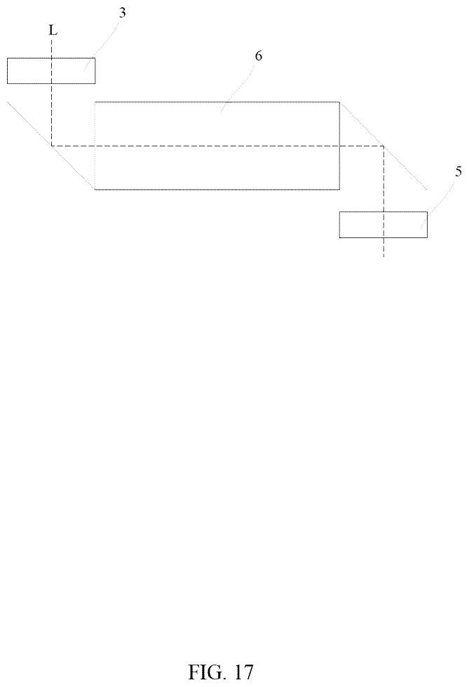

Referring to FIGS. 16 and 17, in some embodiments, the camera module 100 further includes an anti-shake mechanism 5 and a sensor assembly (not shown in the figure) arranged on the anti-shake mechanism 5. The anti-shake mechanism 5 is located on an image side of the autofocus mechanism 2, and the anti-shake mechanism 5 is configured to drive the sensor assembly to move to realize anti-shake. It can be understood that the sensor assembly mainly refers to an optical sensor for imaging. Alternatively, the camera module 100 further includes an optical path folding mechanism 6 arranged between the adjustable diaphragm mechanism 3 and the autofocus mechanism 2, and the optical path folding mechanism 6 is configured to fold an optical path. By the optical path folding mechanism 6, the miniaturization design of the camera module 100 in a certain dimension can be realized, and the periscope telephoto design can also be realized. It can be understood that the anti-shake mechanism 5 includes the above rear housing 51.

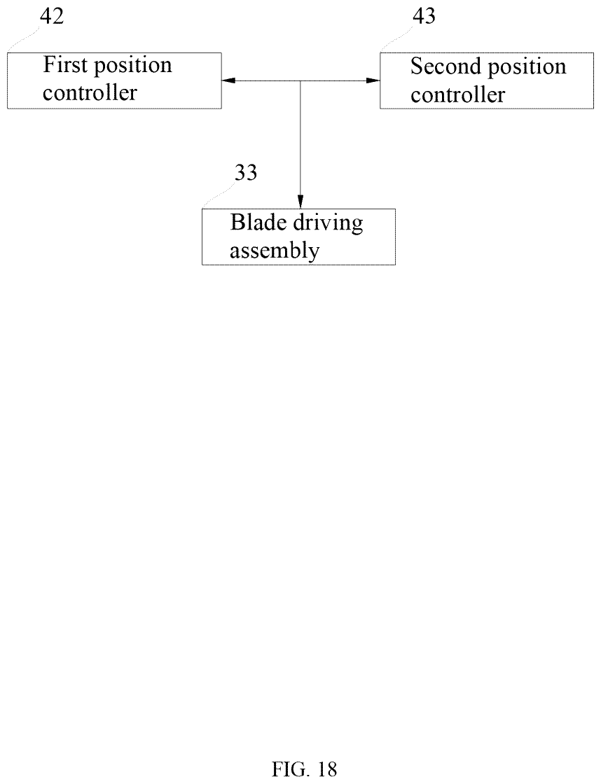

Referring to FIG. 18, a camera module 100 is provided according to a second embodiment of the present disclosure. The camera module 100 in this embodiment is substantially the same as the camera module 100 in the first embodiment, and the main difference is that the first position controller 42 in this embodiment is electrically connected with the coil of the focus driving assembly 22, and the second position controller 43 is electrically connected with the coil of the blade driving assembly 33. The first position controller 42 and the second position controller 43 respectively detect the position of the driving assembly and send current signals to the blade driving assembly 33 according to the corresponding position information, so as to realize consistent adjustment of the lens focus and the aperture of the diaphragm.

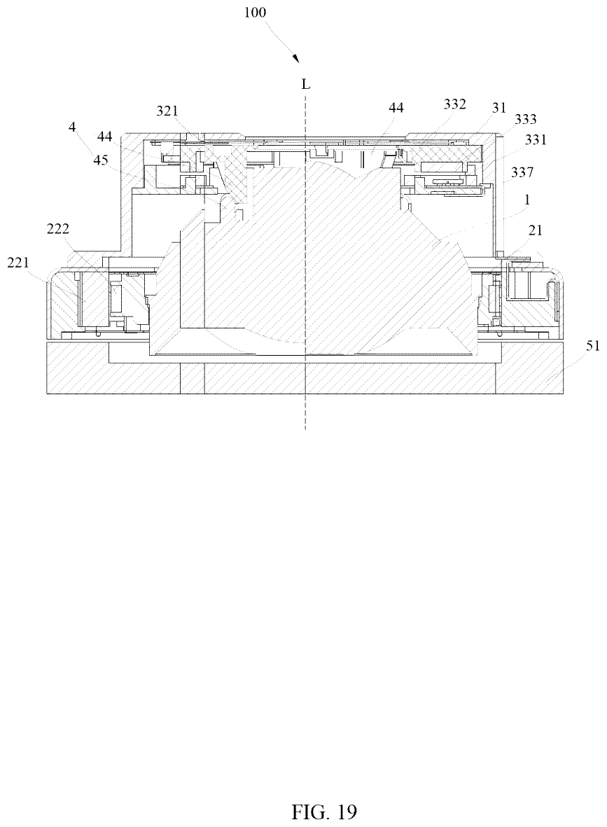

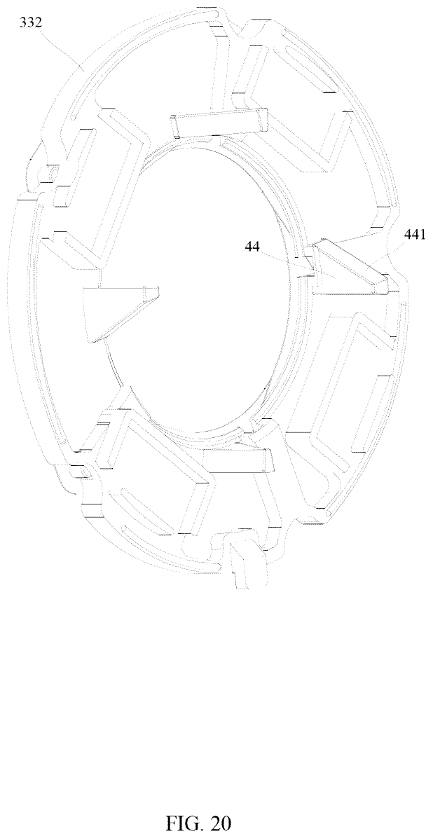

Referring to FIG. 19 and FIG. 20, a camera module 100 is provided according to a third embodiment of the present disclosure. The camera module 100 in this embodiment is substantially the same as the camera module 100 in the first embodiment, and the main difference is that the consistent adjustment of the lens focus and the aperture of the diaphragm in this embodiment is based on physical connection to realize linkage.

Specifically, the linkage mechanism 4 includes an abutment portion 44 arrange on a side of the blade driven ring 332 facing the lens 1, and the lens 1 includes the lens housing 11. The linkage mechanism 4 further includes a protruding portion 45 arranged on a side of the lens housing 11 facing the blade driven ring 332, and the abutment portion 44 abuts against the protruding portion 45. When the focus driving assembly 22 drives the lens 1 to move toward the blade driven ring 332, the protruding portion 45 drives the abutment portion 44 to drive the blade driven ring 332 to rotate, so that the blade driven ring 332 drives the shading blade 32 to move to reduce the aperture of the diaphragm.

It can be understood that when the lens 1 is at an initial position away from the blade driven ring 332, the protruding portion 45 and the abutment portion 44 may just contact, that is, there is no interaction fore between the protruding portion 45 and the abutment portion 44, or there may be a certain force, at this time, the aperture of the diaphragm reaches the maximum. When the focus driving assembly 22 drives the lens 1 to move toward the blade driven ring 332, the protruding portion 45 drives the abutment portion 44 to drive the blade driven ring 332 to rotate, and the aperture of the diaphragm is reduced accordingly, thus ensuring that the field of view of the lens 1 before and after focusing remains unchanged.

In this embodiment, the abutment portion 44 has an inclined surface 441, and the protruding portion 45 abuts against the inclined surface 441. When the lens 1 drives the protruding portion 45 to move toward the blade driven ring 332, the protruding portion 45 pushes the inclined surface 441 and drives the abutment portion 44 to drive the blade driven ring 332 to rotate. In order to better match the protruding portion 45 and the inclined surface 441, an end surface of the protruding portion 45 facing the blade driven ring 332 can be set as a spherical surface or a curved surface similar to a spherical surface. Furthermore, by setting a high surface accuracy, the friction between the protruding portion 45 and the inclined surface 441 can be reduced, for example, the roughness of the inclined surface 441 and the end surface of the protruding portion 45 can be reduced.

In this embodiment, the blade driving assembly 33 further includes a blade angle holder 337, the second driven member is arranged on the blade driven ring 332, and the blade angle holder 337 is arranged opposite to the second driven member. When the focus driving assembly 22 drives the lens 1 to move away from the blade driven ring 332, the blade angle holder 337 drives the second driven member to drive the blade driven ring 332 to rotate, so as to reduce the shielding area of the shading blade 32 on the lens 1.

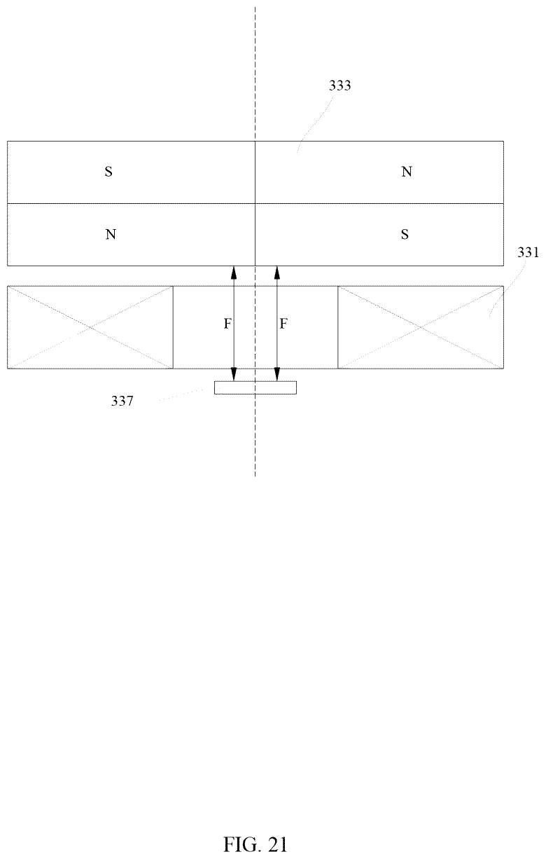

Referring to FIG. 21, specifically, the blade angle holder 337 can be a yoke, which is arranged on the blade support 31 or the mounting ring 334, and is opposite to the second magnetic steel 333 on the blade driven ring 332, for example, directly above the second magnetic steel 333 in the blade driven ring 332, and there is an attractive force f between the yoke and the second magnetic steel 33. The attractive force drives the blade driven ring 332 to maintain the initial position. When the lens 1 moves toward the blade driven ring 332 and the protruding portion 45 pushes the abutment portion 44, it is necessary to overcome the attractive force between the yoke and the second magnetic steel 333, so as to rotate the blade driven ring 332 and reduce the aperture of the diaphragm. When the lens 1 is reset to the initial position, since the protruding portion 45 no longer exerts force on the abutment portion 44, the blade driven ring 332 can be reset to the initial position under the attraction between the yoke and the second magnetic steel 333, that is, the original large aperture of the diaphragm can be restored. It should be noted that in this linkage mode, no matter how the focus driving assembly 22 drives the lens 1 to move, the field of view formed by the lens 1 relative to the aperture of the diaphragm always remains unchanged.

It can be understood that when it is necessary to change the field of view formed by the lens 1 relative to the aperture of the diaphragm, the shading blade 32 can be controlled by the blade driving assembly 33. When the lens 1 moves toward the blade driven ring 332, the aperture of the diaphragm can only be reduced due to the constraints of the abutment portion 44 and the protruding portion 45. When the lens 1 moves toward the initial position, the protruding portion 45 does not exert any force on the abutment portion 44. If it is necessary to keep the aperture of the diaphragm unchanged or further reduce the aperture of the diaphragm, the attractive force between the yoke and the second magnetic steel 333 is overcome by the blade driving assembly 33 to realize the adjustment of the aperture of the diaphragm, thus meeting more shooting mode requirements.

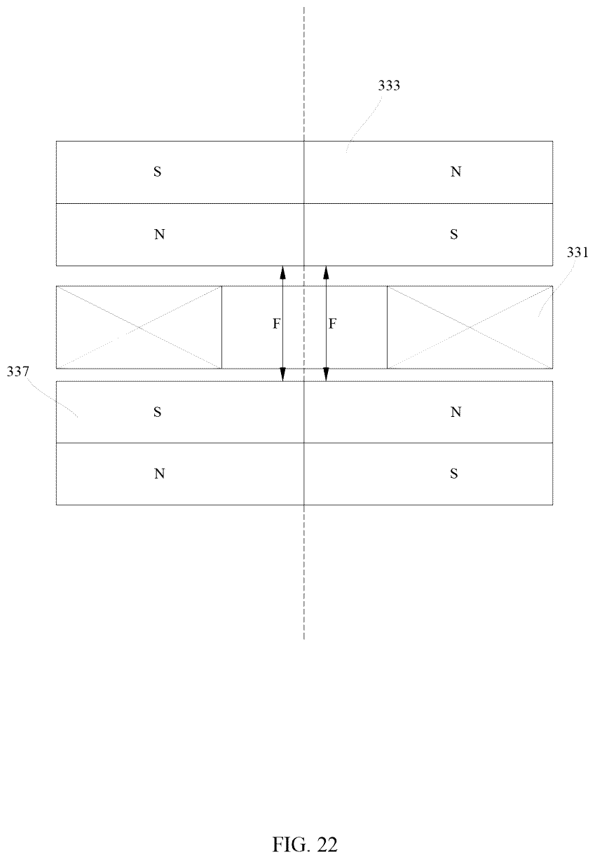

In other embodiments, the blade angle holder 337 may also be magnetic steel, or may be a magnetic fluid encapsulated and fixed to the blade support 31 or the mounting ring 334 by a sealing member. Referring to FIG. 22, it should be noted that when the blade angle holder 337 is magnetic steel, the orientations of different magnetic poles of the blade angle holder 337 should be opposite to the orientations of different magnetic poles of the second magnetic steel 333. For example, the S pole of the blade angle holder 337 is opposite to the N pole of the second magnetic steel 333, and the N pole of the blade angle holder 337 is opposite to the S pole of the second magnetic steel 333.

According to the above embodiment, through the cooperation of the front housing 226 and the rear housing 51, the lens 1 and the autofocus mechanism 2 are set as a whole, and the adjustable diaphragm mechanism 3 becomes a structure independent of the autofocus mechanism 2. However, through physical or electromagnetic cooperation, the focusing movement and the adjustment movement of the aperture of the diaphragm are linked, so that the camera module 100 can synchronously correct the field of view provided by the aperture during focusing, and the driving difficulty of focusing and adjustment of the diaphragm is reduced. In addition, the adjustable diaphragm mechanism 3 is arranged independently of the autofocus mechanism 2, which reduces the weight of the autofocus mechanism 2, prevents the camera module 100 from tilting the lens 1 due to uneven weight distribution, and also avoids the influence of servo control caused by the center of the lens 1 leaning toward the light entering side, without increasing the spring supporting the lens 1. Since the autofocus mechanism 2 and the adjustable diaphragm mechanism 3 can be assembled after their own assembly, the manufacturing difficulty of the camera module 100 is reduced and the stability is high. In addition, the automatic focusing mechanism 2 and the adjustable diaphragm structure 3 are axially assembled, so that the multi-directional protrusion of the camera module 100 can be avoided.

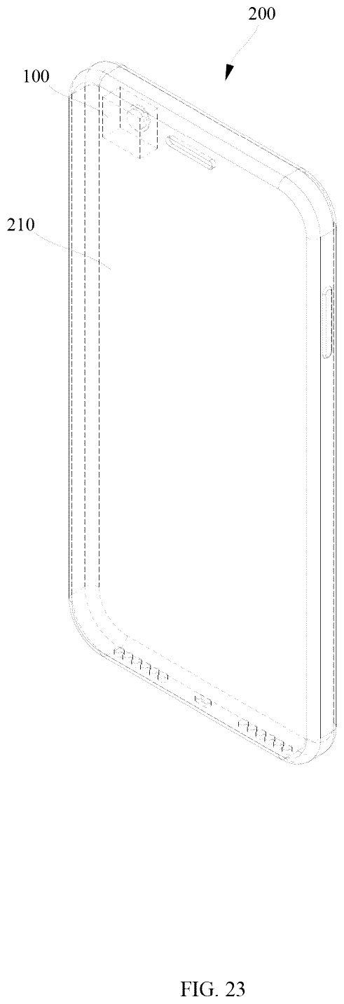

Referring to FIG. 23, an electronic device 200 is provided according to a fourth embodiment of the present disclosure, which includes a device body 210 and the camera module 100 according to any of the above embodiments, and the camera module 100 is arranged on the device body 210.

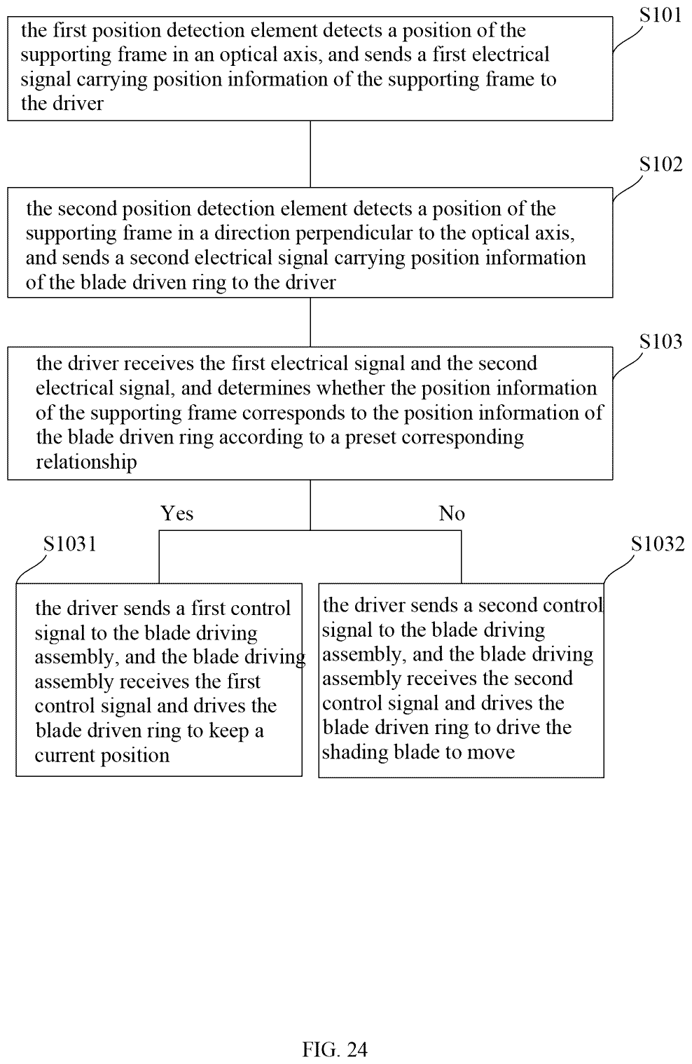

Referring to FIG. 24, a position detection method for a camera module is provided according to a fifth embodiment of the present disclosure, applied to the camera module in the first embodiment, which includes as follows:
S101, the first position detection element 225 detects a position of the supporting frame 21 in the optical axis, and sends a first electrical signal carrying position information of the supporting frame 21 to the driver 41.
S102, the second position detection element 336 detection a position of the supporting frame 21 in a direction perpendicular to the optical axis, and sends a second electrical signal carrying position information of the blade driven ring 332 to the driver 41.
S103, the driver receives the first electrical signal and the second electrical signal, and determines whether the position information of the supporting frame 21 corresponds to the position information of the blade driven ring 332 according to a preset corresponding relationship.
S1031, if the position information of the supporting frame 21 corresponds to the position information of the blade driven ring 332 according to the preset corresponding relationship, the driver 41 sends a first control signal to the blade driving assembly 33, and the blade driving assembly 33 receives the first control signal and drives the blade driven ring 332 to keep a current position.
S1032, if the position information of the supporting frame 21 does not correspond to the position information of the blade driven ring 332 according to the preset corresponding relationship, the driver 41 sends a second control signal to the blade driving assembly 33, and the blade driving assembly 33 receives the second control signal and drives the blade driven ring 332 to drive the shading blade 32 to move.

It can be understood that operation S101 and operation S102 can be performed simultaneously or sequentially. When the operation S101 and operation S102 are performed sequentially in time, either of them may be performed after the other.

For example, the first position detection element 225 detects a position of the supporting frame 21 in the optical axis, which specifically includes as follows: a first position detection magnet is arranged on the supporting frame 21. The first position detection element 225 is a Hall element, and the first position detection element 225 detects the position of the supporting frame 21 by detecting a magnetic flux change of a magnetic field of the first position detection magnet at the first position detection element.

In some embodiments, the first position detection magnet may be the first magnetic steel 221, so that the number of devices inside the camera module 100 can be reduced and the structure can be simplified. In this case, the first position detection element 225 can be fixed to the supporting frame 21. When the supporting frame 21 moves, the first position detection element 225 moves with the supporting frame 21 relative to the first magnetic steel 221, and the first position detection element 225 detects the magnetic flux change during moving, so as to determine the position of the supporting frame 21. After that, the first position detection element 225 sends a first electrical signal including the position information of the supporting frame 21 to the driver 41.

In other embodiments, the first position detection magnet (not shown in the figure) can be separately arranged on the supporting frame 21, and the first position detection element 225 can be fixed to the mounting seat 223 or other components. When the first position detection magnet moves with the supporting frame 21, the first position detection element 225 detects the magnetic flux change to determine the position of the supporting frame 21. It can be understood that when the first magnetic steel 221 is fixed to the supporting frame 21 as a position detection magnet, the first position detection element 225 can also be fixed to the mounting seat 223 or other components.

For example, the second position detection element 336 detects a position of the blade driven ring 332 in a direction perpendicular to the optical axis, which specifically includes as follows: a second position detection magnet is arranged on the blade driven ring 332. The second position detection element 336 is a Hall element, and the second position detection element 336 detects the position of the blade driven ring 332 by detecting a magnetic flux change of a magnetic field of the second position detection magnet at the second position detection element 336.

In some embodiments, the second position detection magnet may be the second magnetic steel 333, so that the number of devices inside the camera module 100 can be reduced and the structure can be simplified. In this case, the second position detection element 333 can be fixed to the mounting ring 334. When the blade driven ring 332 moves, the second position detection element 225 detects the magnetic flux change during moving, to determine the rotation angle of the blade driven ring 332, so as to determine an aperture of the diaphragm. After that, the second position detection element 333 sends a second electrical signal including the position information of the blade driven ring 332 to the driver 41.

In other embodiments, the second position detection magnet (not shown in the figure) can be separately arranged. When the second position detection magnet or the second magnetic steel 333 is fixed to the mounting ring 334, and the second coil 331 is fixed to the blade driven ring 332, the second position detection element 336 is fixed to the blade driven ring 332.

For operation S103, after receiving the first electrical signal and the second electrical signal, the driver 41 performs matching analysis on the position of the supporting frame 21 and the position of the blade driven ring 332 according to the position information of the supporting frame 21 included in the first electrical signal and the position information of the blade driven ring 332 included in the second electrical signal.

When it is determined that the positions of the supporting frame 21 and the blade driven ring 332 conform to the preset corresponding relationship, it means that it is unnecessary to adjust the aperture of the diaphragm. In this case, the driver 41 sends the first control signal to the blade driving assembly 33, so that the second coil 331 drives the blade driven ring 332 to keep a fixed position to maintain the aperture of the diaphragm.

When it is determined that the position of the supporting frame 21 and the position of the blade driven ring 332 do not conform to the preset corresponding relationship, it means that the position of the lens 1 relative to the diaphragm is changed, resulting in the change of the field of view of the lens 1 relative to the aperture of the diaphragm. In this case, it is necessary to adaptively adjust the aperture of the diaphragm to keep the field of view of the lens 1 relative to the aperture of the diaphragm unchanged. Therefore, the driver 41 sends the second control signal to the blade driving assembly 33, so that the second coil 331 drives the blade driven ring 332 to drive the shading blade 32, thereby adaptively changing the aperture of the diaphragm.

It should be noted that the first control signal and the second control signal are generally current signals with appropriate directions and magnitudes. When the first control signal or the second control signal passes through the second coil 331, the second coil 331 generates a magnetic field and interacts with the second magnetic steel 333 to drive the second magnetic steel 333 to drive the blade driven ring to rotate.

During the detection process, the first position detection element 225 and the second position detection element 336 input the detected magnetic flux change signal into the driver 41, and the driver 41 replaces the magnetic flux change signal with a code, such as, 0-1023 or 0-4095. It should be noted that the magnetic flux change within the maximum range of the focus driving and the maximum range of diaphragm driving are generally replaced with codes. In the driver 41, in order to match the driving position and the code, it is necessary to measure the stroke of the focus driving, the optical anti-shake or the diaphragm driving by using the forming amount measuring device to take the value.

The code of 0-1023 and the stroke of 1000 μm is taken as an example. When the code is 0, the stroke is 0 μm, when the code is 512, the stroke is 500 μm, and when the code is 1023, the stroke is 1000 μm. That is, code 0=0 μm, code 512=500 μm and code 1023=1000 μm. At this time, the control signal output from the driver 41 is approximately equal to the magnetic flux value, the code value, the stroke value, thereby realizing control.

The corresponding relationship between the position information of the supporting frame 21 and the position information of the blade driven ring 332 is similar to the rotation angles of the lens 1 and the blade driven ring 332 in the first embodiment.

When the driver 41 is controlled by the blade control module 411, the blade control module 411 can convert the received magnetic flux change signal into a corresponding code, match the actual stroke according to the code, and then send a control signal to the blade driving assembly 33.

When the first position controller 42 is used to replace the first position detection element 225 and the second position controller 43 is used to replace the second position detection element 336, the first position controller 42 and the second position controller 43 detect positions of each other, so as to determine the change of the relative position between the adjustable diaphragm and the lens 1, and send the information including the change of the position to the driver 41. The driver 41 sends a control signal to the blade driving assembly 33 according to the above change of the position.

In other feasible solution, in addition to the TMR element such as Hall element that detects the magnetic flux change, a resistance sensing element that detects the change of resistance can be used to realize position detection, or a light sensing element can be provided to realize position detection by detecting the change of light receiving amount of the sensor caused by the change of the position of the lens during focusing movement. In addition, the driver 41 can be a driver with a built-in Hall element or a driver for calculating the received electrical signal, which can be selected and adaptively adjusted according to actual needs, which is not specifically limited by the present disclosure.

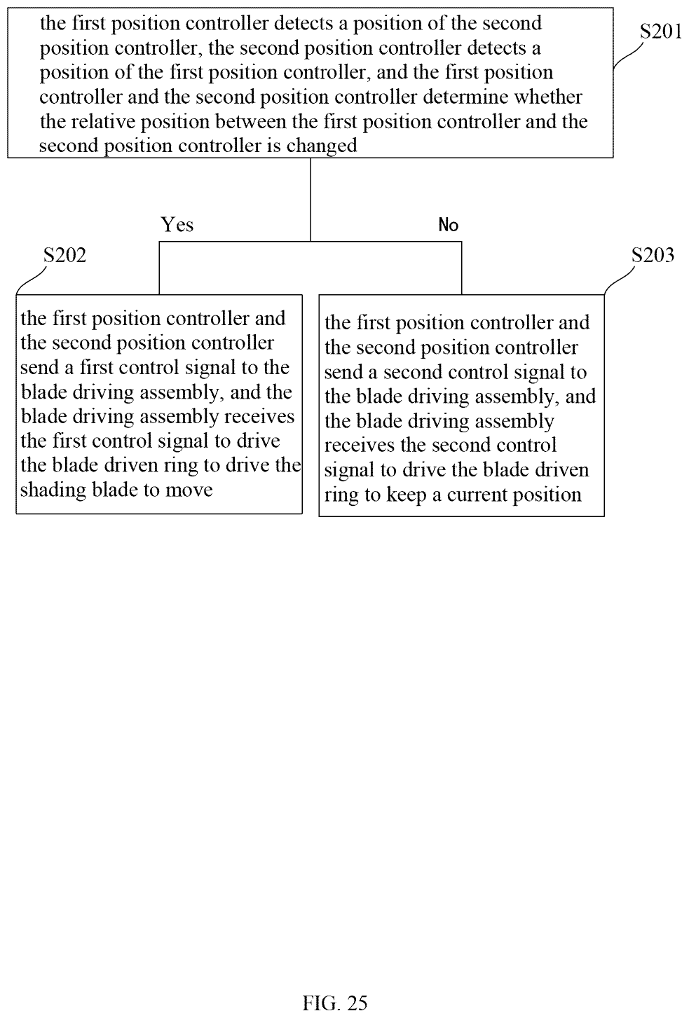

Referring to FIG. 25, a position detection method of a camera module is provided according to a sixth embodiment, applied to the camera module 100 in the second embodiment, which includes as follows:
S201, the first position controller 42 detects a position of the second position controller 43, the second position controller 43 detects a position of the first position controller 42, and the first position controller 42 and the second position controller 43 determine whether the relative position between the first position controller 42 and the second position controller 43 is changed.
S202, if the relative position between the first position controller 42 and the second position controller 43 is changed, the first position controller 42 and the second position controller 43 sends a first control signal to the blade driving assembly 33, and the blade driving assembly 33 receives the first control signal to drive the blade driven ring 332 to drive the shading blade 32 to move.
S203, if the relative position between the first position controller 42 and the second position controller 43 is not changed, the first position controller 42 and the second position controller 43 sends a second control signal to the blade driving assembly 33, and the blade driving assembly 33 receives the second control signal to drive the blade driven ring 332 to keep a current position.

For operation S201, when the first position controller 42 and the second position controller 43 detect the change of the position by detecting the magnetic flux change, the first position controller 42 and the second position controller 43 may be components with the internal Hall elements, and position detection magnets are provided on the supporting frame 21 and the blade driven ring 332. The first position controller 42 detects the position detection magnet on the blade driven ring 332, and the second position controller 43 detects the position detection magnet on the supporting frame 21. The first position controller 42 and the second position controller 43 can calculate the magnetic flux change signal detected by the Hall element, so as determine the driving position.

It can be understood that in this embodiment, the first position controller 42 and the second position controller 43 can also determine the driving position by detecting the change of the resistance value of the resistor or the change of the light receiving amount.

The camera module, the electronic device and the position detection method for the camera module provided by the embodiments of the present I disclosure have been described in detail above. The principle and implementation of the present disclosure are explained by using specific examples herein. The description of the above embodiments is only for helping to understand the idea of the present disclosure, and there will be changes in the specific embodiments and application scope. To sum up. the contents of this specification should not be understood as limiting the present disclosure.

What is claimed is:

1. A camera module, comprising:
a lens;
an autofocus mechanism, including a supporting frame and a focus driving assembly, wherein the supporting frame is sleeved on and fixed to an outer circumference of the lens to support the lens, and the focus driving assembly is configured to drive the supporting frame to move the lens along an optical axis of the lens;
an adjustable diaphragm mechanism, including a blade support, a shading blade and a blade driving assembly, wherein the blade support, the shading blade and the blade driving assembly are located on an object side of the lens, the blade support and the lens are coaxially arranged, and the shading blade is located between the blade support and the blade driving assembly, wherein the blade support has a positioning hole, the shading blade has a positioning portion, the positioning portion rotatably extends into the positioning hole, and the shading blade is rotatable around the positioning portion; and
a linkage mechanism, wherein in response to the focus driving assembly driving the supporting frame to drive the lens to move, the linkage mechanism drives the blade driving assembly to drive the shading blade to move, to adaptively change a shading area of the shading blade on the lens.

2. The camera module according to claim 1, wherein the linkage mechanism includes a driver electrically connected with the focus driving assembly and the blade driving assembly, and the driver detects a position of the supporting frame by the focus driving assembly and controls the blade driving assembly to drive the shading blade to move according to the position of the supporting frame.

3. The camera module according to claim 2, wherein the focus driving assembly includes a first driving member and a first position detection element, the first position detection element is electrically connected with the driver, the first driving member is configured to drive the supporting frame to move along the optical axis, the driver detects the position of the supporting frame by the first position detection element and controls the blade driving assembly to drive the shading blade to move according to the position of the supporting frame.

4. The camera module according to claim 3, wherein the blade driving assembly includes a second driving member, a blade driven ring and a second position detection element, wherein the second driving member is located between the shading blade and the lens, the blade driven ring is located between the shading blade and the second driving member, the shading blade is further slidably connected with the blade driven ring, and the second position detection element is electrically connected with the driver;
wherein the second driving member is configured to drive the blade driven ring to drive the shading blade to move, and the driver detects a position of the blade driven ring by the second position detection element and controls the second driving member to drive the shading blade to move according to the position of the blade driven ring.

5. The camera module according to claim 2, wherein the driver includes a blade control module, the focus driving assembly includes a first driving member and a first position detection element, the first position detection element is electrically connected with the blade control module, and the blade driving assembly is electrically connected with the blade control module;
wherein the first driving member is configured to drive the supporting frame to move along the optical axis, and the blade control module detects the position of the supporting frame by the first position detection element and controls the blade driving assembly to drive the shading blade to move according to the position of the supporting frame.

6. The camera module according to claim 5, wherein the blade driving assembly includes a second driving member, a blade driven ring, and a second position detection element, the second driving member is located between the shading blade and the lens, the blade driven ring is located between the shading blade and the second driving member, the shading blade is further slidably connected with the blade driven ring, and the second driving member and the second position detection element are electrically connected with the blade control module;
wherein the second driving member is configured to drive the blade driven ring to drive the shading blade to move, and the blade control module detects a position of the blade driven ring by the second position detection element and controls the second driving member to drive the shading blade to move according to a rotation angle of the blade driven ring.

7. The camera module according to claim 2, wherein the linkage mechanism further includes a first position controller and a second position controller, wherein the first position controller is arranged on the supporting frame, the focus driving assembly includes a first driving member located on an image side of the supporting frame, the blade driving assembly includes a second driving member, the second position controller is arranged on the second driving member, and both the first position controller and the second position controller are electrically connected with the driver;
wherein the first driving member is configured to drive the supporting frame to move along the optical axis, the second driving member is configured to drive the shading blade to move, the first position controller and the second position controller are configured to detect a relative position of each other to determine a current position of the lens, and the driver controls the blade driving assembly to drive the shading blade to move according to the current position of the lens.

8. The camera module according to claim 7, wherein the blade driving assembly includes a mounting ring, the second driving member, and a blade driven ring, the mounting ring is located between the shading blade and the lens, the second driving member is located between the shading blade and the mounting ring, the blade driven ring is located between the shading blade and the second driving member, the shading blade is further slidably connected with the blade driven ring, the second driving member is electrically connected with the driver, and the second position controller is arranged on the mounting ring;
wherein in response to the lens moving along the optical axis, the first position controller and the second position controller detect the relative position of each other along the optical axis.

9. The camera module according to claim 1, wherein the linkage mechanism includes a first position controller and a second position controller, wherein the first position controller is arranged on the supporting frame, the focus driving assembly includes a first driving member located on an image side of the supporting frame, the blade driving assembly includes a second driving member, the second position controller is arranged on the second driving member, and both the first position controller and the second position controller are electrically connected with the second driving member;
wherein the first driving member is configured to drive the supporting frame to move along the optical axis, the second driving member is configured to drive the shading blade to move, the first position controller and the second position controller are configured to detect a relative position of each other to determine a current position of the lens, and the second driving member drives the shading blade to move according to the current position of the lens.

10. The camera module according to claim 1, wherein the blade driving assembly includes a blade driven ring, the blade driven ring is located between the shading blade and the lens, the linkage mechanism includes an abutment portion located on a side of the blade driven ring facing the lens, the lens includes a lens housing, the linkage mechanism further includes a protruding portion located on a side of the lens housing facing the blade driven ring, and the protruding portion abuts against the abutment portion;
wherein in response to the focus driving assembly driving the lens to move toward the blade driven ring, the protruding portion drives the abutment portion to drive the blade driven ring to rotate, to increase the shading area of the shading blade on the lens.

11. The camera module according to claim 10, wherein the abutment portion has an inclined surface, the protruding portion abuts against the inclined surface, and the protruding portion pushes the inclined surface and drives the abutment portion to drive the blade driven ring to rotate in response to the lens driving the protruding portion to move toward the blade driven ring.

12. The camera module according to claim 10, wherein the blade driving assembly further includes a second driven member and a blade angle holder, the second driven member is arranged on the blade driven ring, and the blade angle holder is arranged opposite to the second driven member;
wherein in response to the focus driving assembly driving the lens to move away from the blade driven ring, the blade angle holder drives the second driven member to drive the blade driven ring to rotate, to decrease the shading area of the shading blade on the lens.

13. The camera module according to claim 10, wherein the focus driving assembly further includes a first driving member and a first driven member, the first driven member is a first coil wound around a periphery of the supporting frame, and the first driving member is a plurality of first magnetic steels surrounding the first coil and arranged at intervals on an outer side of the first coil, the first magnetic steels drive the first coil to drive the supporting frame to move along the optical axis in response to the first coil being energized;
wherein the blade driving assembly includes a second driving member, the blade driven ring and a second driven member, the blade driven ring is arranged between the shading blade and the lens, the shading blade is further slidably connected with the blade driven ring, the second driven member is a plurality of second magnetic steels surrounding the optical axis and are fixed to the blade driven ring at intervals, and the second driving member is a plurality of second coils surrounding the optical axis and are arranged at intervals, and the plurality of second coils drive the plurality second magnetic steels to drive the blade driven ring to rotate in response to the second coils being energized.

14. The camera module according to claim 1, wherein the autofocus mechanism further includes a zoom assembly, and the zoom assembly is configured to drive the focus driving assembly and the supporting frame to move along the optical axis to realize zooming.

15. The camera module according to claim 1, wherein the camera module further comprises an anti-shake mechanism and a sensor assembly arranged on the anti-shake mechanism, wherein the anti-shake mechanism is located at an image side of the autofocus mechanism, and the anti-shake mechanism is configured to drive the sensor assembly to move to realize anti-shake; or
the camera module further comprises an optical path folding mechanism located between the adjustable diaphragm mechanism and the autofocus mechanism, wherein the optical path folding mechanism is configured to fold an optical path.

16. An electronic device, comprising a device body and the camera module according to claim 1, wherein the camera module is arranged on the device body.

17. A position detection method for the camera module according to claim 4, comprising:
detecting, by the first position detection element, the position of the supporting frame in the optical axis, and sending, by the first position element, a first electrical signal carrying position information of the supporting frame to the driver;
detecting, by the second position detection element, a position of the blade driven ring in a direction perpendicular to the optical axis and sending, by the second position detection element, a second electrical signal carrying position information of the blade driven ring to the driver;
receiving, by the driver, the first electrical signal and the second electrical signal, and
determining, by the driver, whether the position information of the supporting frame corresponds to the position information of the blade driven ring according to a preset corresponding relationship;
in response to the position information of the supporting frame corresponding to the position information of the blade driven ring according to the preset corresponding relationship, sending, by the driver, a first control signal to the blade driving assembly, and receiving, by the blade driving assembly, the first control signal to drive the blade driven ring to keep a current position; and
in response to the position information of the supporting frame not corresponding to the position information of the blade driven ring according to the preset corresponding relationship, sending, by the driver, a second control signal to the blade driving assembly, and receiving, by the blade driving assembly, the second control signal and to drive the blade driven ring to drive the shading blade to move.

18. The position detection method according to claim 17, wherein the detecting, by the first position detection element, the position of the supporting frame in the optical axis includes:
arranging a first position detection magnet on the supporting frame, wherein the first position detection element is a Hall element, and the first position detection element detects the position of the supporting frame by detecting a magnetic flux change of a magnetic field of the first position detection magnet at the first position detection element.

19. The position detection method according to claim 17, wherein the detecting, by the second position detection element, a position of the blade driven ring in a direction perpendicular to the optical axis includes:
arranging a second position detection magnet on the blade driven ring, wherein the second position detection element is a Hall element, and the second position detection element detects the position of the blade driven ring by detecting a magnetic flux change of a magnetic field of the second position detection magnet at the second position detection element.

20. A position detection method for the camera module according to claim 9, comprising:
detecting, by the first position controller, a position of the second position controller, detecting, by the second position controller, a position of the first position controller, and determining, by the first position controller and the second position controller, whether the relative position between the first position controller and the second position controller is changed;
in response to the relative position between the first position controller and the second position controller being changed, sending, by the first position controller and/or the second position controller, a first control signal to the blade driving assembly, and receiving, by the blade driving assembly, the first control signal to drive the blade driven ring to drive the shading blade to move;
in response to the relative position between the first position controller and the second position controller being not changed, sending, by the first position controller and/or the second position controller, a second control signal to the blade driving assembly, and receiving, by the blade driving assembly, the second control signal to drive the blade driven ring to keep a current position.
